(19) United States
(12) Patent Application Publication
(10) Pub. No.: US 2014/0070994 A1
(43) Pub. Date: Mar. 13, 2014

(54) 3D SHORT RANGE DETECTION WITH PHASED ARRAY RADAR

(71) Applicants: Paul Donald Schmalenberg, Ann Arbor, MI (US); Jae Seung Lee, Ann Arbor, MI (US); Koji Shiozaki, Ann Arbor, MI (US)

(72) Inventors: Paul Donald Schmalenberg, Ann Arbor, MI (US); Jae Seung Lee, Ann Arbor, MI (US); Koji Shiozaki, Ann Arbor, MI (US)

(73) Assignee: Toyota Motor Engineering & Manufacturing North America, Inc., Erlanger, KY (US)

(21) Appl. No.: 13/613,111

(22) Filed: Sep. 13, 2012

(51) Int. Cl. H01Q 3/30

(52) U.S. Cl. 342/368

(57) ABSTRACT

A radar microchip for short range detection with phased array radar uses phase shifters along with an antenna array to steer the transmitted and received radar beams along orthogonal axes to achieve a 3D scan. Individual phase shifters connected to antenna cells that transmit and receive the radar beams steer the radar along two orthogonal axes by controlling the phase of the radar. The radar then detects where the two beams overlap. The antenna cells are further aligned along these orthogonal axes. An isolation barrier between the phase shifters of the transmitted and received signals reduces cross coupling on the radar microchip.

### FIELD OF THE INVENTION

The invention relates to a radar microchip for detecting objects and, more specifically, a radar microchip used in automobiles to improve target classification of threatening and non-threatening objects.

### BACKGROUND OF THE INVENTION

Radar systems are often used on automobiles to provide information about the area surrounding the automobile to a vehicle system such as an adaptive cruise control, various control systems and the like. Basic radar systems generally contain a transmitting antenna array, a receiving antenna array and associated hardware necessary to process the signals. As integrated circuit technology has advanced, the size and cost of such components has decreased to the point where radar systems can be contained on a single microchip and have become commonplace on automobiles.

The majority of current commercial automotive radar systems scan in two dimensions (2D). These systems are limited to 2D scans in a single plane due to cost and practicality. Conventional 2D radar systems are often only able to provide information on an object's range and azimuth. Many of these systems scan in a horizontal direction about the front of the automobile and as such the systems do not have vertical resolution. The system scans with a fixed vertical window and cannot distinguish between objects on the road surface and those suspended above the road surface. Due to the planar nature of the scan, in a practical application the radar system's algorithm can be confused by objects above the road like traffic signals and interpret these objects as being on the road surface which can lead the system to falsely identify the objects as collision threats.

While normal 2D radar provides information on an object's range and azimuth, three dimensional (3D) radar systems are additionally able to provide information on the object's elevation. This allows 3D radar systems to locate objects within 3D space and more accurately model the surrounding area. Two common techniques to implement 3D radar include stacked beam and steered beam radars. Stacked beam radars derive elevation by emitting narrow beams which are stacked vertically over a predetermined vertical range. Steered beam radars scan 3-dimensionally by steering a narrow beam through a predetermined scan pattern.

Modern automobile systems rely on a plethora of sensor networks to provide information about the ever changing environment around the vehicle. Being able to correctly classify objects surrounding a vehicle and identifying those that may be threatening has become an increasingly arduous task for these sensor networks. It would be preferential to use a 3D radar system in automobiles but because of their prohibitive cost, these systems have seen limited use outside of weather forecasting and military applications. Therefore, an affordable and cost effective 3D radar system for use in automobiles would be desirable.

### SUMMARY OF THE INVENTION

In accordance with the invention, a radar microchip capable of a 3D scan is provided. Individual phase shifters are connected to each cell of transmitting and receiving antenna arrays which allows a radar system to control transmitted and received radar signals or beams. The cells of the antenna arrays can be stacked and aligned orthogonal to one another which enables the radar system to control radar beams in both horizontal and vertical directions. In this manner, the microchip can combine stacked beam and steered beam techniques to achieve a cost effective 3D scan with improved object classification relative to existing automotive radar systems.

The 3D scan of the present invention is realized by a combination of phase shifters on chip coupled with an antenna layout. The phase shifters are present in both transmitting and receiving portions of the radar system. In a preferred embodiment of the present invention, the phase shifters of the transmitting and receiving portions of the radar microchip are located on a single printed circuit board (PCB). An isolation barrier is further incorporated into the PCB layout to reduce cross coupling between the transmitting and receiving portions of the radar microchip.

A single microchip or a plurality of radar microchips can provide a grid like array of antennas to transmit and receive a radar signal. The antenna array can be formed by a plurality of individual antenna cells which are placed along two orthogonal axes. Beginning at the vertex of these two axes, antenna cells can extend outwardly therefrom to form two distinct arrays or lines of antenna cells. One line of antenna cells is for transmitting the radar beam and the other orthogonal line of antenna cells is for receiving the radar beam.

While the axes need merely be orthogonal to one another to achieve a 3D scan, in a preferred embodiment, the transmitting line of antenna cells are stacked along a horizontal line relative to a road surface. The receiving line of antenna cells are further stacked along a vertical line relative to the road surface. The transmitting and receiving lines ideally have the same number of antenna cells per line, however this is not required.

At least one phase shifter from the transmitting portion of the radar microchip is connected to each individual cell of the transmitting line of antenna cells and affords for the radar microchip to control the radar beam in the horizontal direction. Likewise, at least one phase shifter from the receiving portion of the radar microchip is connected to each individual cell of the receiving line of antenna cells and affords the radar microchip to control the radar beam in the vertical direction.

Controlling the radar beam in both the horizontal and vertical directions allows the radar microchip to move the beam throughout a scanning area. The radar microchip can also detect where the transmitted and received beams overlap within the scanning area, thereby affording the location of objects within 3D space using the range, azimuth, and elevation information obtained from the 3D scan. It is appreciated that locating objects with a 3D scan can improve target classification of threatening and non-threatening objects.

### BRIEF DESCRIPTION OF THE DRAWINGS

A better understanding of the present invention will be had upon reference to the following detailed description when read in conjunction with the accompanying drawings, wherein like reference characters refer to like parts throughout the several views, and in which:

FIG. 1 illustrates an exemplary layout of a radar microchip according to an embodiment of the present invention;

FIG. 2 illustrates an exemplary layout of the radar microchip shown in FIG. 1 with connections between phase shifters and antenna cells;

FIG. 3 is a simulation of a radar beam versus scan direction for a receiving array;

FIG. 4 is a simulation of a radar beam versus scan direction for a transmitting array; and

FIG. 5 is a simulation of a combination of transmitting and receiving beams versus scan direction which results in a thin beam capable of scanning in all directions.

### DETAILED DESCRIPTION OF A PREFERRED EMBODIMENT OF THE PRESENT INVENTION

A microchip for transmitting and receiving radar signals is provided. The microchip can have a plurality of receiving phase shifters and a plurality of transmitting phase shifters. In addition, the microchip can have a plurality of transmitting antenna cells along a first axis and a plurality of receiving antenna cells along a second axis. In some instances, the second axis is orthogonal to the first axis. At least one of the transmitting phase shifters can be linked to each of the transmitting antenna cells and at least one of the receiving phase shifters can be linked to each of the receiving antenna cells.

An isolation barrier can be present on the microchip and separate the transmitting phase shifters from the receiving phase shifters. The isolation barrier can be constructed by a series of vertical interconnect accesses (vias) through all layers of a multilayer microchip and connect the layers to a ground layer.

The receiving phase shifters can be grouped as a receiving array on the microchip and the transmitting phase shifters can be grouped as a transmitting array on the microchip. In some instances, the transmitting array can be distinct and separate from the receiving array. In addition, the isolation barrier on the microchip can be located between the receiving array and the transmitting array.

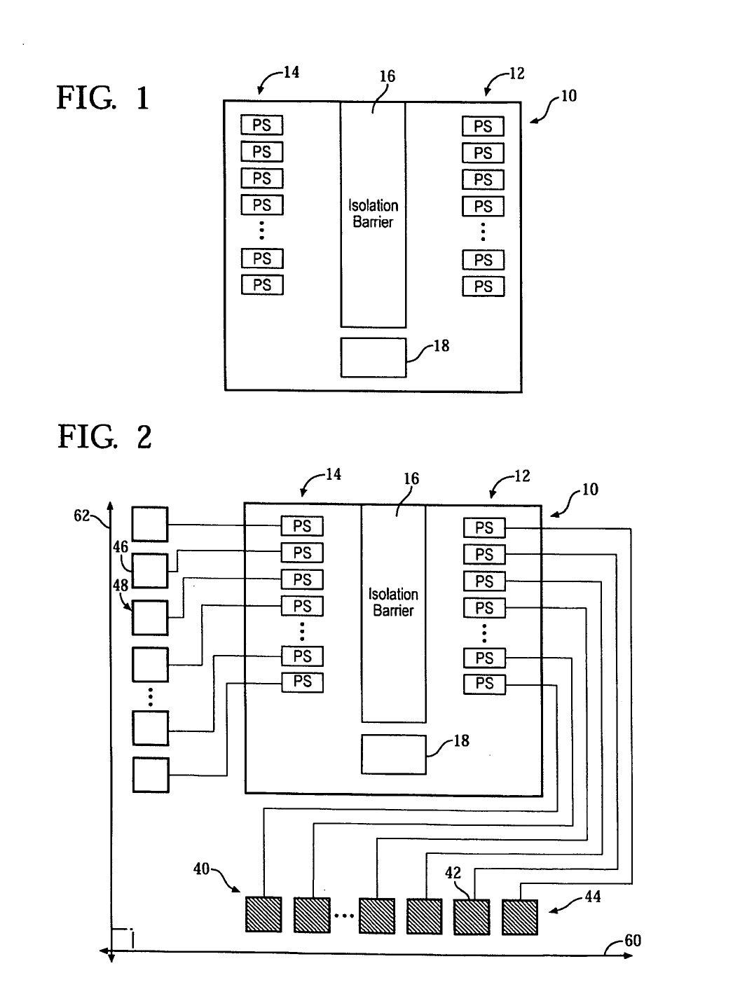

With reference first to FIG. 1, a radar microchip 10 is provided. The radar microchip 10 can include a plurality of transmitting phase shifters 12, a plurality of receiving phase shifters 14, an isolation barrier 16, and additional components common to radar microchips such as mixers 18. In a preferred embodiment, the various components of the radar microchip 10 are placed on a multiple layer printed circuit board (PCB).

The transmitting phase shifters 12 can be used to control the phase of a radar signal or beam and steer the beam sent by the radar microchip 10. The receiving phase shifters 14 are also used to control the phase of the radar signal and steer the beam as it is received by the radar microchip 10. The transmitting phase shifters 12 are collectively grouped and separated from the receiving phase shifters 14 by the isolation barrier 16.

The isolation barrier 16 is placed between the transmitting phase shifters 12 and the receiving phase shifters 14 to reduce cross coupling between the transmitted and received signals. Cross coupling can occur when electrical signals are adversely influenced by interference, such as that from other signals on a microchip. The close proximity between the transmitting phase shifters 12 and the receiving phase shifters 14 on the radar microchip 10, along with the sensitivity of the signals they carry or process, makes them especially susceptible to cross coupling which can compromise the performance of the radar scan by increasing error in the signals.

The isolation barrier 16 can be made up by a series of vertical interconnect accesses (vias) through layers of a multiple layer radar microchip 10 PCB. Within the region of the isolation barrier 16, the vias can connect a plurality of metal layers of the radar microchip 10 to a ground plane. The electrically grounded area of the isolation barrier 16 can reduce the cross coupling between the transmitting phase shifters 12 and the receiving phase shifters 14. In this manner the isolation barrier 16 can afford for an overall size of the radar microchip 10 to be decreased by allowing the transmitting phase shifters 12 and receiving phase shifters 14 to be in close proximity to one another on the radar microchip 10 PCB while protecting radar signals from the negative effects of cross coupling.

FIG. 2 illustrates an arrangement of a preferred embodiment of the radar microchip 10 and a radar antenna array 40. The radar antenna array 40 can be a plurality of individual transmitting antenna cells 42 and receiving antenna cells 46. The transmitting antenna cells 42 are aligned about a first axis 60 to form a transmitting antenna array 44. The receiving antenna cells 46 are aligned about a second axis 62 to form a receiving antenna array 48. The first axis 60 and the second axis 62 are orthogonal to one another and in a preferred embodiment the first axis 60 is generally horizontal and the second axis 62 is generally vertical.

Each transmitting antenna cell 42 in the transmitting antenna array 44 can be connected to at least one of the transmitting phase shifters 12 of the radar microchip 10. Similarly, each receiving antenna cell 46 in the receiving antenna array 48 can be connected to at least one of the receiving phase shifters 14 of the radar microchip 10. In addition, the phase of each antenna cell in the radar antenna array 40 can be independently controlled by one or more of the radar microchip, 10 phase shifters. It is appreciated that changing the phase of the radar beam across either the transmitting antenna array 44 or the receiving antenna array 48 allows the system to steer the radar beam along the first axis 60 direction or the second axis 62 direction, respectively.

The transmitting antenna cells 42 and receiving antenna cells 46 of the radar antenna array 40 can be any type of antenna cells used in a short range phased array radar system and known to those skilled in the art, illustratively including microstrip patch antennas, slotted waveguide antennas, printed dipole antennas and the like. Such antennas can configured within the cell as a linear (series) fed array, corporate fed array, sequentially fed array, or any combination thereof. In a preferred embodiment, the transmitting antenna cells 42 and the receiving antenna cells 46 are integrated onto the same PCB as the radar microchip 10.

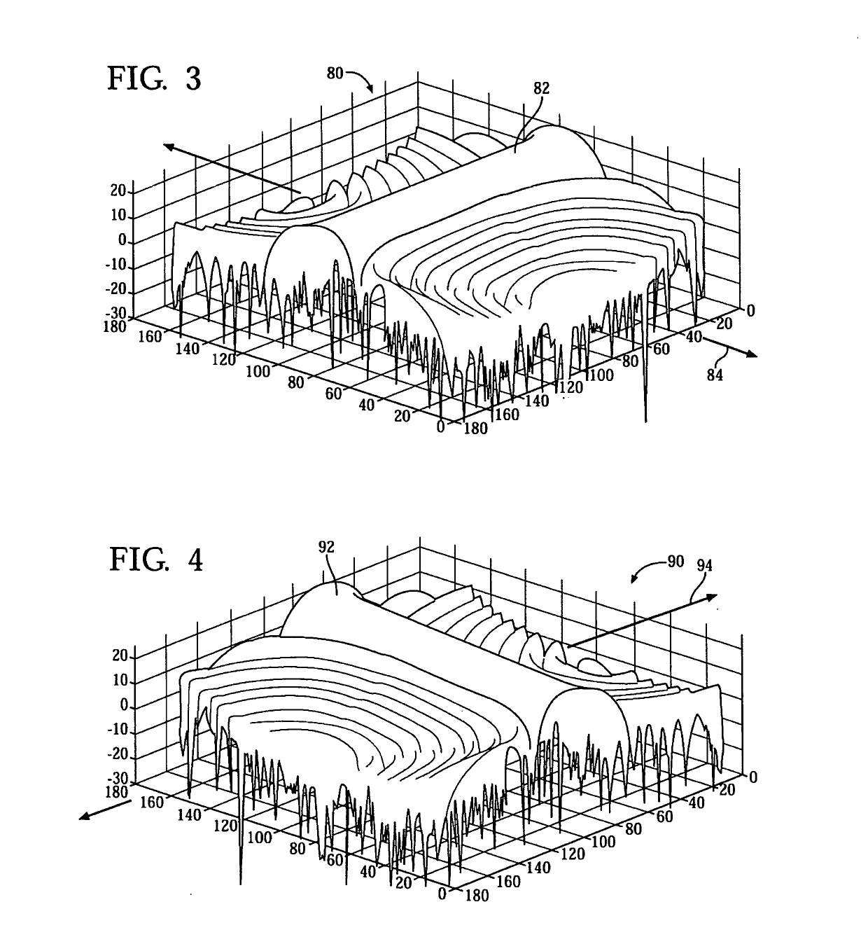

Turning now to FIG. 3, a first simulation 80 illustrating a received radar beam 82 along a receiving scan axis 84 is provided. The receiving phase shifters 14 control the phase of the received radar beam 82 and steer the received radar beam 82 along the receiving scan axis 84. In addition, the receiving scan axis 84 can be parallel to the second axis 62 shown in FIG. 2 with both axes being in a generally vertical direction.

FIG. 4 illustrates a second simulation 90 of a transmitted radar beam 92 along a transmitting scan axis 94. The transmitting phase shifters 12 control the phase of the transmitted radar beam 92 and steer the transmitted radar beam 92 along the transmitting scan axis 94. In addition, transmitting scan axis 94 can be parallel to the first axis 60 shown in FIG. 2 with both axes being in a generally horizontal direction.

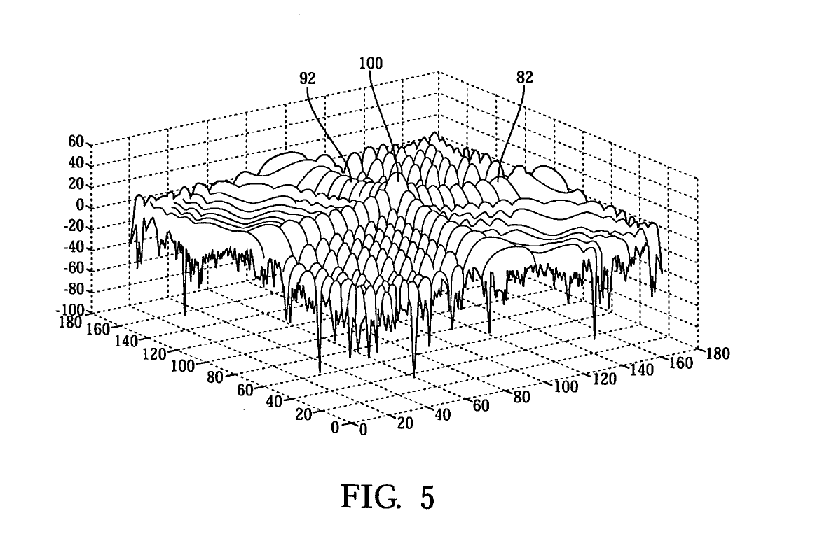

A simulation of the transmitted radar beam 92 combined with the received radar beam 82 is shown in FIG. 5. Such a simulation illustrates that the radar microchip 10 can detect where the transmitted radar beam 92 overlaps the received radar beam 82 within a scanned area or volume at a convergence point 100. In addition, the overlapping beams at the convergence point 100 can be used to determine a target's range, azimuth, and elevation. As such, scanning both the transmitted 92 and received radar beams 82 along their respective scan axes 94, 84, a 3D scan can be achieved.

From the foregoing, it can be seen that the present invention provides a radar microchip that uses phase shifters along with an antenna array to steer the transmitted and received radar beams along orthogonal axes to achieve a 3D scan. Having described the invention, however, many modifications thereto will become apparent to those skilled in the art to which it pertains without deviation from the spirit of the invention as defined by the scope of the appended claims.

We claim:

1. A microchip for transmitting and receiving radar signals comprising:
a plurality of receiving phase shifters and a plurality of transmitting phase shifters on the microchip;
a plurality of transmitting antenna cells along a first axis of the microchip;
a plurality of receiving antenna cells along a second axis of the microchip, said second axis orthogonal to said first axis; and
wherein at least one said transmitting phase shifter is linked to each transmitting antenna cell and at least one said receiving phase shifter is linked to each receiving antenna cell.

2. The microchip of claim 1, further comprising:
an isolation barrier on the microchip separating said transmitting phase shifters from said receiving phase shifters.

3. The microchip of claim 1, further comprising:
said isolation barrier constructed by a series of vias through all layers of the microchip and connected to a ground layer.

4. The microchip of claim 1, further comprising:
said receiving phase shifters grouped as a receiving array on the microchip.

5. The microchip of claim 1, further comprising:
said transmitting phase shifters grouped as a transmitting array on the microchip, said transmitting array arranged to be distinct and separate from said receiving array.

6. The microchip of claim 1, further comprising:
said isolation barrier arranged on the microchip to reside between said receiving array and said transmitting array.

7. A microchip mounted to a vehicle for transmitting and receiving radar signals comprising:
a plurality of receiving phase shifters and a plurality of transmitting phase shifters on the microchip;
a plurality of transmitting antenna cells along a first axis of the;
a plurality of receiving antenna cells along a second axis of the microchip, said second axis orthogonal to said first axis; and
wherein at least one said transmitting phase shifter is linked to each transmitting antenna cell and at least one said receiving phase shifter is linked to each receiving antenna cell such that the microchip can control a radar beam in both the vertical and horizontal directions relative to the vehicle.

8. The microchip of claim 7, further comprising:
said first axis aligned horizontally along the microchip relative to the vehicle.

9. The microchip of claim 7, further comprising:
said second axis aligned vertically along the microchip relative to the vehicle.

10. The microchip of claim 7, further comprising:
an isolation barrier on the microchip separating said transmitting phase shifters from said receiving phase shifters.

11. The microchip of claim 7, further comprising:
said isolation barrier constructed by a series of vias through all layers of the microchip and connected to a ground layer.

12. The microchip of claim 7, further comprising:
said receiving phase shifters grouped as a receiving array on the microchip.

13. The microchip of claim 7, further comprising:
said transmitting phase shifters grouped as a transmitting array on the microchip, said transmitting array arranged to be distinct and separate from said receiving array.

14. The microchip of claim 7, further comprising:
said isolation barrier arranged on the microchip to reside between said receiving array and said transmitting array.
